(19) United States
(12) Patent Application Publication
(10) Pub. No.: US 2013/0039145 A1
(43) Pub. Date: Feb. 14, 2013

(54) E-Z SHAKE

(71) Applicants: Felicia Lynne Pollaro, Hamilton, NJ (US); Mark Brian Docherty, Hamilton, NJ (US)

(72) Inventors: Felicia Lynne Pollaro, Hamilton, NJ (US); Mark Brian Docherty, Hamilton, NJ (US)

(73) Assignee: EAZY ENTERPRISES LLC, Hamilton, NJ (US)

(21) Appl. No.: 13/206,125

(22) Filed: Aug. 9, 2011

(51) Int. Cl. B01F 11/00; B01F 15/00; B01F 15/06

(52) U.S. Cl. 366/142; 366/237; 366/145; 366/143

(57) ABSTRACT

Presented herein is a mixing apparatus to mix liquid and solids, solids and solids, liquids and liquids or combinations thereof into a homogenous solution in a sealed container shaken in a side to side, up and down, and/or orbital pattern with a warming plate to heat the contents to a desired temperature or for a specific time period with a decreased risk of foreign contaminants in accordance with prescribed instructions for preparing a mixture.

### RELATED APPLICATION

The present application claims priority to and the benefit of U.S. Provisional Patent Application No. 61376399, with a filing date at the U.S. Patent and Trademark office on Aug. 24, 2010, the entire contents are incorporated by this reference.

### BACKGROUND OF THE INVENTION

1. Field of the Invention

The present invention pertains generally to an apparatus to mix ingredients in a sealed container, and more specifically a shaker using an oscillating motion coupled with heat to thoroughly combine a powder and liquid in a bottle to reduce the introduction of uwanted foreign objects.

2. Description of the Prior Art

The standard regime of preparing formula in a baby bottle involves several steps. First, a prescribed amount of powdered baby formula must be placed within a bottle. Water must be measured, often after being heated and cooled, and then poured into the bottle, affixing the top of the bottle with a nipple, and shaking by hand the solution until it appears to be properly mixed.

A drawback from this regime is, even after thorough shaking, usually non-homogenous mixing, lumps, or unmixed powder collect at the bottom of the bottle, which can plug the nipple opening and cause ingestion of these lumps leading to upset stomachs in small infants. Several reasons explain this issue. Shaking is a very subjective procedure, which can be performed incorrectly by parents for a number of reasons including exhaustion, weakness of the arms, lack of uniform motions in shaking, and/or failure to follow the instructions as given by the formula manufacturers.

A number of prior techniques and machines have been developed for mixing of solutions comprised of two or more ingredients in a sealed container. However, none have been able to accommodate specific instructions for shaking as prescribed by manufacturers of the ingredients to be mixed (such as in the example of baby formula). One such device, U.S. patent application No. 2010/0027981 describes a warmer for heating liquids for use with powdered infant formula. The device comprises an external water reservoir and pump, heating element, and carafe demarcated in ounces to allow the user to easily add the appropriate amount of infant formula after the water is warmed. However, this only follows part of the traditional regime for baby formula preparation and no shaking is involved as normally prescribed to ensure a homogenous solution free of lumps. Another mixing regime makes use of an attachable shaker top mixing chamber, as described in U.S. Pat. No. 4,818,114, to prevent sticking of the powder to crevices within the container. This mechanism again does not ensure a uniform shaking motion that would address subjective error on the part of individuals preparing the mixtures or potential exhaustion and/or physical inability of parents.

Some designs make use of a mixing apparatus similar to a blender. Devices such as those described in U.S. Pat. Nos. 7,673,824, 4,351,612, and 5,970,847 and U.S. patent application No. 2006/0007781 employ the use of blades and/or stirrers inserted into a container or mixing chamber where the ingredients will be combined. However, this fails to follow the basic instructions of sensitive mixing regimens such as the baby formula which seek to prevent the introduction of foreign objects which may contaminate the solution. Furthermore, none of these devices contain a mechanism for holding a specialized container, such as a baby bottle, which would then proceed to be shaken in a prescribed manner. Instead, the solution would require being transferred from a mixing apparatus to the container itself, creating an additional risk of contamination and clumping. Similarly, although the prior art does make some mention of heating elements, the heating is isolated to the liquid component of the solution and not heating of the mixed solution for immediate use.

Thus, despite the attempt made by skilled practitioners in the art, a mixing apparatus that can accommodate specifically prescribed instructions for preparing mixtures such as baby formula in a uniform manner without manual labor or unnecessary risk of contamination has been unattainable until the advent of the present invention.

While certain aspects of conventional technologies have been discussed to facilitate disclosure of the invention, Applicants in no way disclaim these technical aspects, and it is contemplated that the claimed invention may encompass one or more of the conventional technical aspects discussed herein.

### SUMMARY OF THE INVENTION

In one non-limiting preferred embodiment of the invention, the invention is a motorized countertop bottle shaker for mixing one or more substances homogeneous with a baby's bottle for immediate use. The invention contains a mechanism for clamping and holding the bottles being mixed during the mixing process. The clamps are either latched by a handle, screw set, latch or similar mechanism to move the upper part of the invention to make contact with the upper part of the bottle and provide sufficient force so the bottom part of the bottle make contact with the bottom part of the invention to both hold in place and transmit the orbital vibrating motion to the bottle and its contents. The clamp may be automatically or manually lowered to secure the bottle within the invention.

The invention can be powered by convention electrical connections, by battery powered or other electrical source. In one non limiting embodiment, the invention can be used in alternate areas of a dwelling or business. For example, a baby's nursery, bedroom, office, day care center and other non-limiting variations.

The invention is not limited to mixing of only one powder and one liquid and is applicable to mixing of one or more powders, liquids, premade solutions or combinations thereof. In one non limiting embodiment the invention contains a timer or pre programmable circuit to set the mixing time and have the invention automatically stop mixing when the set time has been reached. In another non limiting embodiment when the mixing cycle is complete the invention provides a noise, vibration, light or other means to identify the completion of the mixing.

The invention has the distinct advantage of keeping the solution contaminant free since it does not require the insertion of a foreign object to mix the solution eliminating lumps and providing a homogeneous mixture per the manufactures instructions for solutions such as powdered baby formula. In one non limiting embodiment, the invention can be used to mix other powders and liquids. For example, the invention can be used to homogeneously mix protein drinks, dietary supplements, digestive aids, energy drinks or alcoholic beverages.

In one non limiting embodiment, the invention is able to secure one bottle. In another non limiting embodiment the invention is able to secure two or more bottles. In another non limiting embodiment the invention may have an external light source for use in dark spaces or when it is desired not to turn on the lights within an occupied space (i.e., a nightlight).

The present invention may address one or more of the problems and deficiencies of the prior art discussed above. However, it is contemplated that the invention may prove useful in addressing other problems and deficiencies in a number of technical areas. Therefore the claimed invention should not necessarily be construed as limited to address any of the particular problems or deficiencies discussed herein.

### BRIEF DESCRIPTION OF THE DRAWINGS

FIG. 1 is a front view of the mixing apparatus;

FIG. 2 is an isometric view of the mixing apparatus of FIG. 1;

FIG. 3 is an exploded view of the base of the mixing apparatus FIG. 1, exposing the orbital vibration mechanism providing the mixing capabilities;

FIG. 4 is a front view of the orbital vibration mechanism of FIG. 1;

FIG. 5 is a side view of the orbital vibration mechanism of FIG. 1;

FIG. 6 is a front view of the mixing apparatus exposing the crank pulley mechanism of FIG. 1;

FIG. 7 is an exploded view of the crank assembly handle of FIG. 6;

FIG. 8 is an exploded view of the self locking clamp mechanism of FIG. 6; and

FIG. 9 is an electrical schematic of the mixing apparatus of FIG. 1.

### DETAILED DESCRIPTION OF THE DRAWINGS

The figures contained herein are representative of one non limiting embodiment of the disclosed invention and are not intended to be inclusive of all functions and or features as provided by the specification and claims.

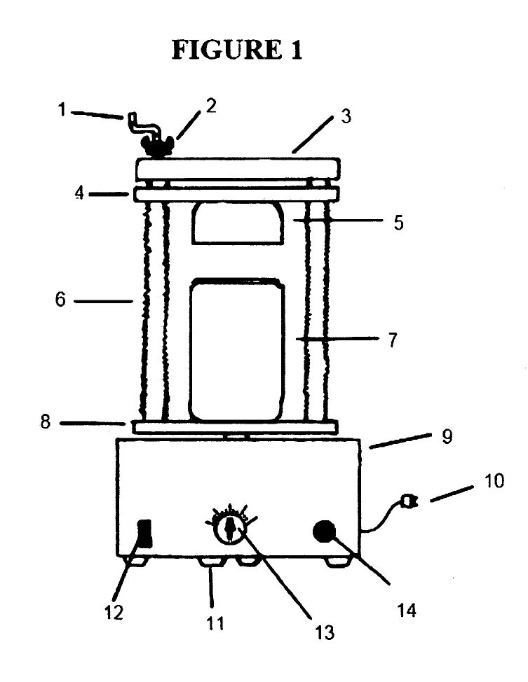

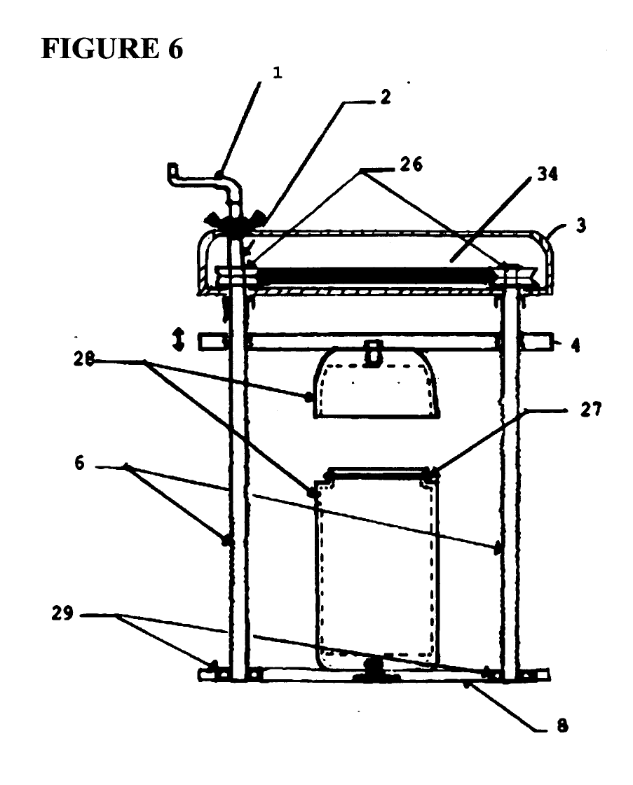

FIG. 1 represents a front view of the mixing apparatus depicting its base 9 which can be constructed from various materials such as metal, plastic or combination thereof. The base 9 of FIG. 1 includes grommets 11 at its base to assist in absorbing the residual vibration so as to not transmit it to the counter top. The grommets 11 are constructed of a material to create a high surface tension between the grommets and the counter top to assist in keeping the mixing apparatus in position during use. Extending from the base of the mixing apparatus is a plug 10 to engage an electrical outlet to provide electrical power to the mixing apparatus as shown in FIG. 1. In one non limiting embodiment the plug 11 provides a alternate power source for mixing apparatus primarily powered by batteries. The base 9 as shown in FIG. 1 contains a power switch 12, a light indicator 14 and a timer dial 13. In one non limiting embodiment the light indicator 14 can be made to be in the on position to provide an external light source within a room. The mixing apparatus as shown in FIG. 1 has two threaded rods 6 extending from the bottom clamp plate 8 which is held in position by attachment screw 22. The threaded rods 6 may not be threaded the entire length of the rod or may not be threaded at all in the case where the clamping mechanism of FIGS. 6, 7 and 8 is a purely mechanical locking linkage or other type of clamping mechanism. To hold a a user's container such as a bottle in position, the mixing apparatus in FIG. 1 contains a holding container 28 with lower body 7 and upper cap 5 attached to top clamp plate 4. In one non limiting embodiment, the user's container is placed within the lower body of the holding container 7 and the cap 5 is lowered over the bottle or mixing container making contact with the holding container 7 securing the bottle or mixing container in position. The cap 5 is lowered onto the holding container 7 by turning the crank handle 1 until the cap 5 make contact with the lower body of the holding container 7. Once the holding container 28 is completely closed and prior to operation the self locking wing nut 2 is engaged to ensure the clamp remains in position during operation. The top enclosure 3 of FIG. 1 encloses the crank system.

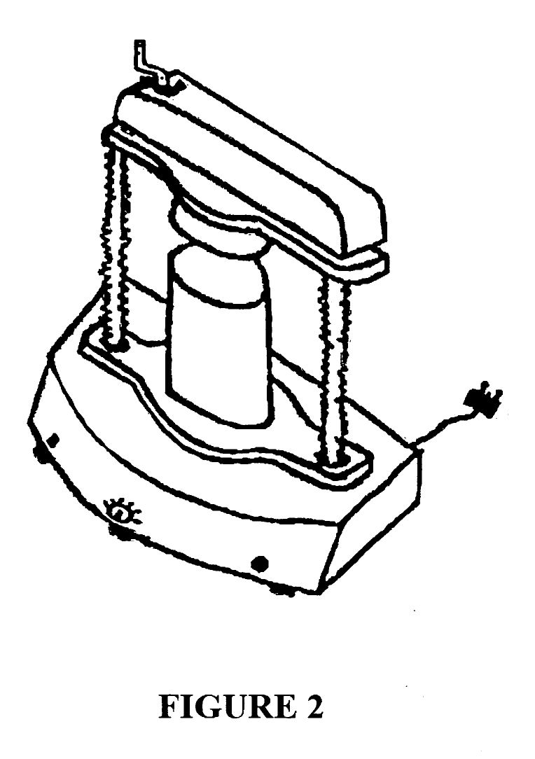

FIG. 2 represents an isometric view of the mixing apparatus of FIG. 1.

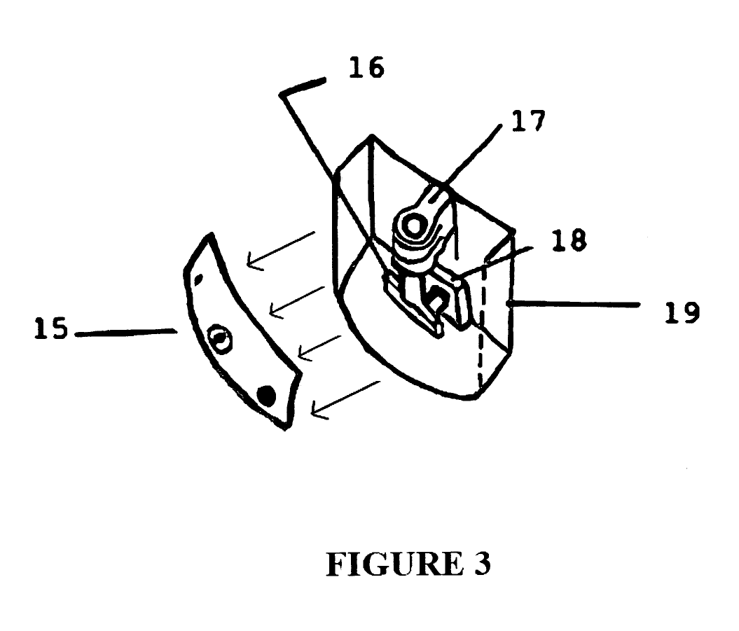

FIG. 3 represents an exploded view of the inner components of the base 9 as depicted in FIG. 1. The base 9 is composed of a main body 19 and a front plate 15. Within the body 19 are the inner components that provide the mixing to mixing apparatus. The inner components are a motor 18 slider mechanism 16 and a linear bearing housing 17.

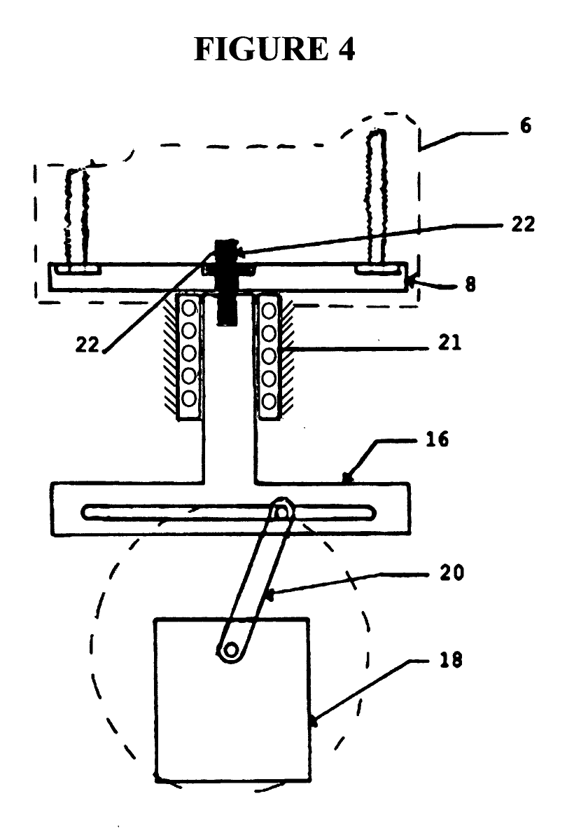

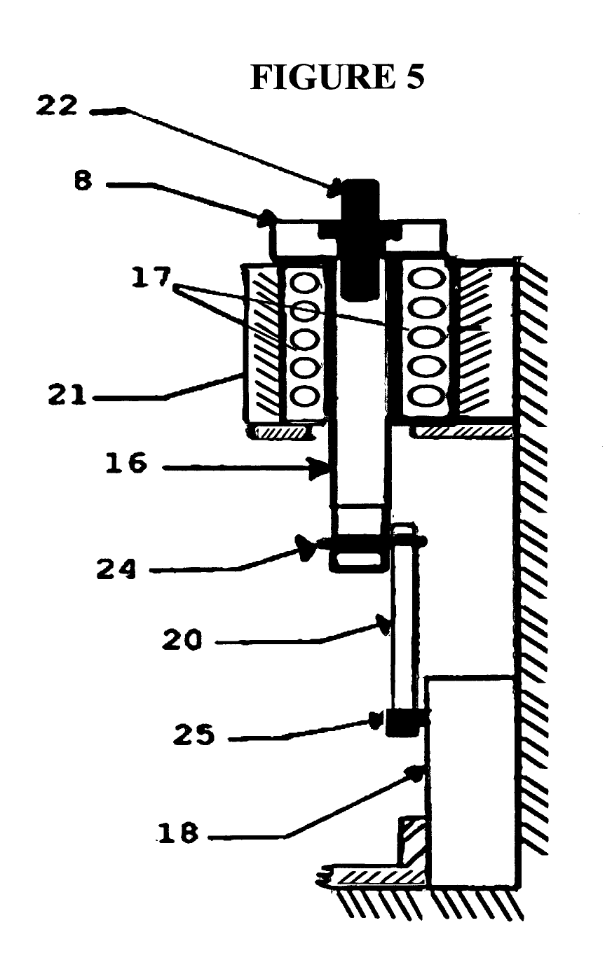

FIGS. 4 and 5 provide a more detailed description of the inner components of the mixing apparatus. In FIG. 4 the electrical motor 18 is connected to the slider mechanism 16 by an inner crank 20 which transmits the motion of the motor to bottom clamp plate 8 via the slider mechanism and a linear bearing 21. As shown in FIG. 5 the inner crank 20 is held to the electrical motor 18 and slider mechanism 16 by a output shaft 25 extended from the electrical motor and making contact with the inner crank 20 and a connecting pin 24 that connects the inner crank 20 to the slider mechanism 16. The motion is then transmitted to the holding container 28 by the linear bearing 21 held within the linear bearing housing 17.

FIG. 6 depicts a cutaway view of the upper portion of the mixing apparatus as shown in FIG. 1 exposing the inner workings of the clamping mechanism and a cutaway view of the holding container 28. At the place of contact of the lower body of the holding container 7 and the cap 5 a o-ring 27 is used to create a tight seal between the lower body of the holding container 7 and the cap 5 to guard against any potential leakage if the mixing bottle was not completely closed prior to use of the mixing apparatus. Within the top enclosure 3 of the crank system are two pulleys 26 connected by a belt 34 and attached to the threaded rods 6 so the entire top enclosure 3 and bottom plate 4 move as one unit in lowering the cap 5 of the holding container onto the lower body of the holding container 7.

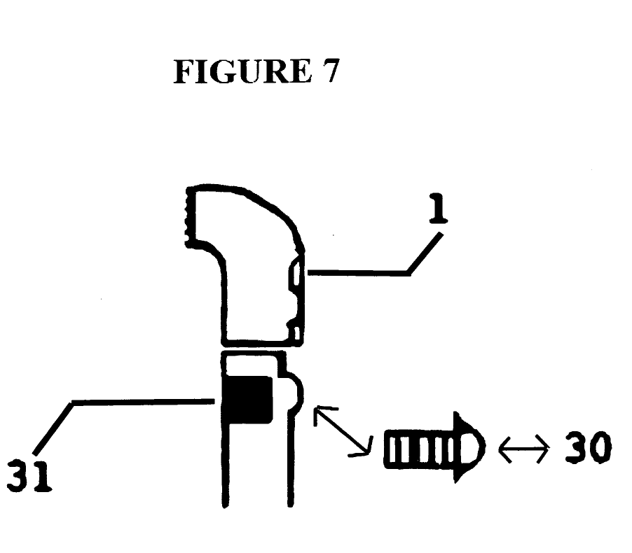

The crank handle 1 is removable for the mixing apparatus as shown in FIG. 7 by depressing the spring plunger assembly 31 and 32.

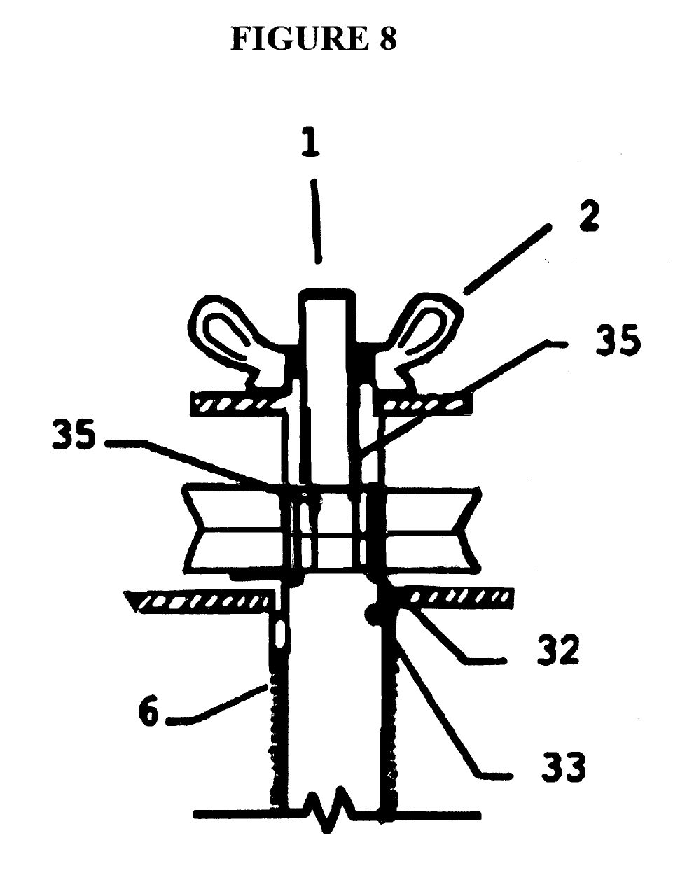

FIG. 8 provides a detailed look into the construction of the crank handle 1 and self locking wing nut 2 the top of the threaded rods 6 contain two ledges 33 and 32 used to secure the top enclosure 3 and pulleys 26, respectively. The assembly as shown in FIG. 8 contains an internal threaded rod 35 to secure the wing nut 2 after the top clamp plate 4 is in position.

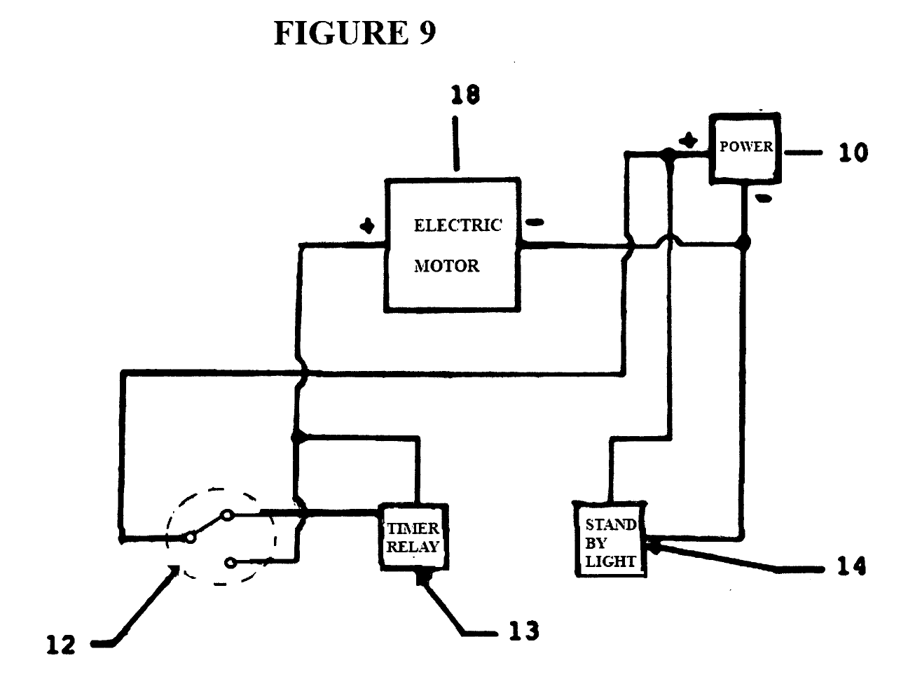

FIG. 9 shows an electric schematic of one non limiting embodiment of the mixing apparatus containing the electrical motor 18, power source 10, power switch 12, light indicator 14 and a timer dial 13.

We claim:

1. A mixing apparatus to mix liquid and solids, solids and solids, liquids and liquids or combinations thereof into a homogenous solution in at least one sealed container oscillating in a side to side, up and down, and/or orbital pattern.

2. The mixing apparatus of claim 1, which includes a mechanism to hold and release said container within said apparatus during and after mixing operation.

3. The mixing apparatus of claim 1, which includes a heating element to warm the contents of said container prior to, during, and after the mixing operation wherein said heating element turns off after a predetermined time or temperature has been reached.

4. The mixing apparatus of claim 1, which includes a mechanical or electronic control mechanism to predetermine the time of the mixing operation.

5. The mixing apparatus of claim 4, which includes a display for indicating completion of said mixing operation.

6. The mixing apparatus of claim 1, which includes an external light source.

7. The mixing apparatus of claim 1, which includes an electrical power source derived from batteries.

8. The mixing apparatus of claim 1, which includes electrical power derived from direct connection to an electrical socket.

9. The mixing apparatus of claim 7, containing a single informing user of completion of mixing operation.

10. The mixing apparatus of claim 9, where electrical power is derived from batteries.

11. The mixing apparatus of claim 9, where electrical power is derived from a direct connection to an electrical socket.

12. The mixing apparatus of claim 1, containing an external light source.

13. The mixing apparatus of claim 1, wherein a container fits into a predetermined and pre-shaped space in said mixing apparatus conformed to the external shape of said container and is secured in place by a holding mechanism.

14. The mixing apparatus of claim 13, wherein said container has an open end with internal screwthreads proportioned and dimensioned to permit the attachment of said container to a pre-shaped space in said mixing apparatus.

15. The mixing apparatus of claim 13, wherein said container is transparent and has delineated markings for assessing an amount of liquid in said container.

16. The mixing apparatus of claim 13, wherein said container comprises at least two separate chambers for holding contents to be mixed.

17. The mixing apparatus of claim 16, wherein at least one of said separate chambers in said container is capable of attaching to said mixing apparatus by said holding mechanism.
